(19) United States
(12) Patent Application Publication
(10) Pub. No.: US 2006/0234578 A1
(43) Pub. Date: Oct. 19, 2006

(54) Fireproof composite yarn comprising two types of fibers

(76) Inventor: Christian Paire, BONNEFAMILLE (FR)

Correspondence Address: YOUNG & THOMPSON, 745 SOUTH 23RD STREET, 2ND FLOOR, ARLINGTON, VA, 22202, US

(21) Appl. No.: 10/522,803

(22) PCT Filed: Jul. 30, 2003
(86) PCT No.: PCT/FR03/02424

§ 371 Date: Jan. 20, 2006

(30) Foreign Application Priority Data
Jul. 31, 2002 (FR) 02/09769

(51) Int. Cl. B32B 27/12

(52) U.S. Cl. 442/136

(57) ABSTRACT

A fireproof composite yarn includes between 80 and 90 percent by weight of flameproof fibers containing a polymeric material based on polyvinyl alcohol, between 10 and 30 percent by weight of at least one type of thermostable fibers made of a non-flammable material. The invention also relates to a fabric having at least one woven or knitted textile layer that is made of such a yarn.

The invention concerns a fire-resistant composite yarn and a textile comprising at least one woven or knitted textile layer formed with such a yarn.

The textile is typically intended to produce protective clothing, in particular garments for the military, or for fire fighters or used in industry. In particular, the use of the textile is suited when the garment must confer a certain degree of thermal protection on the user.

For such applications, it is known how to use yarns comprising thermostable fibers which confer on the garment good fire resisting and mechanical strength performance—particularly in terms of resistance to abrasion, toughness and stability during use or various washings that the garment will have to undergo.

However, one problem which is posed with thermostable fibers is the impossibility of dying or printing them in a simple fashion, in particular with a standard technique of the fixed wash type.

This is why, in the applications in question, the yarns of the prior art are coloured by a technique of the pigmentary type in which the dyes are coated on the yarns.

However, this technique does not make it possible to obtain a sufficiently resistant colouring, in particularly vis-à-vis abrasion, since the coating is only weakly connected to the yarns.

In addition, another problem which is posed is that of the high cost of the thermostable fibers.

This is why it has been proposed to use yarns comprising a mixture of thermostable fibers and flame-retarded fibers of lesser cost.

However, in order to obtain a composite yarn which satisfies the specific constraints of the uses in question, in particular in terms of mechanical strength and fire-resistant properties, the prior art proposes to use flame-retarded fibers which must be combined with more than 50% by weight of thermostable fibers.

However, in such a percentage, the colouring constraints mentioned above remain, so that it has been proposed to include in the thermostable fibers a specific dye which is arranged to merge into the colours applied subsequently on the cloth.

This solution only partially gives satisfaction, in particular because of the high percentage of thermostable fibers, and is particularly limiting for a military application in which the initial quality or the quality after maintenance of the printed or dyed colours has a direct influence on the quality of the camouflage conferred by the garment.

The invention therefore aims to remedy this drawback by proposing in particular a composite yarn comprising a lower percentage of thermostable fibers, and this without affecting either the mechanical properties or the fire-resisting properties of the said yarn.

Thus, when the cloth is printed or dyed in a single phase, that is to say using a single colouring process and therefore using for example self-coloured thermostable fibers, the cloth has reduced dichroism in proportion to the reduction in the quantity of thermostable fibers.

In addition, still because of the reduction in the percentage of the thermostable fibers, the yarn proposed has a lower production cost compared with that of the prior art.

To this end, and according to a first aspect, the invention proposes a fire-resistant composite yarn comprising:
between 70% and 90% by weight of flame-retardant fibers, the said fibers comprising a polymeric material based on polyvinyl alcohol;
between 10% and 30% by weight of at least one type of thermostable fibers which are formed from a non-flammable material.

According to a second aspect, the invention proposes a textile intended for producing protective clothing, the said textile comprising at least one woven or knitted textile layer formed with such yarns.

Other objects and advantages of the invention will emerge during the following description.

The invention concerns a fire-resisting composite yarn composed of a combination of specific fibers, the said yarn being in particular able to be used for producing a textile for protecting clothing, for example for the military or for fire fighters or used in industry. This is because in such applications the constraints, in particular in terms of fire resisting and mechanical strength properties are more and more severe so that there exists a significant demand for improving the known fibers, and this within a controlled cost.

The yarn comprises fibers which comprise a polymer material based on polyvinyl alcohol.

However, this type of material is not non-flammable as it stands. This is why, in order to obtain a fire resisting yarn, the fibers used must be flame retarded.

To this end, the flame-retarded fibers can comprise a flame-retarding polymer material. In a particular example, the flame-retarding material can be a polyvinyl halide, in particular a polyvinyl chloride which, when it burns, releases a sufficient quantity of chlorine to make the fiber non-flammable.

The flame-retarded fibers thus obtained therefore have, when they are subjected to a flame or to a significant source of heat, the dual property of not propagating flame and retarding the temperature increase of the yarn by virtue of the partial fusion of the fibers.

The problem which is posed with such flame-retarded fibers is that of their thermal stability. This is because the absorption of thermal energy is obtained by virtue of the partial fusion of the fibers, which gives rise to a deformation of these.

To mitigate this drawback, the flame-retarded fibers are associated with at least one type of thermostable fibers which are formed from a non-flammable material. Thermostable means fibers which preserve their physical properties in temperatures where the other fibers have lost them.

The function of the thermostable fibers is, in particular, to reinforce, in addition to the thermal properties, the mechanical performance of the yarn. In particular, the use of these fibers makes it possible to obtain resistance to abrasion, toughness and stability, in particular during use or various washings, which is compatible with the production of protective clothing. In addition, the thermostable fibers limit the formations of holes in the cloth when this is subjected to a flame, and therefore improves the fire resistant protection conferred by the garment. Finally, the thermostable fibers also have an advantageous affect on the limitation of the thermal shrinkage of the yarn.

The applicant carried out tests and found that, in combination with the particular flame-retarded fibers used, the contribution of the thermostable fibers was advantageous as soon as they were present in a quantity of 10% with respect of the total weight of the yarn. This small percentage is particularly advantageous because on the one hand of the cost of these thermostable fibers and on the other hand the impossibility of printing or dying them with simple techniques, in particular with the techniques conventionally used for flame-retarded fibers. This constraint is particularly significant in the military field because the quality of the colours printed or dyed has a direct influence on the quality of the camouflage conferred by the garment. And the small minimum percentage of thermostable fibers necessary in the yarn according to the invention also makes it possible to use thermostable fibers in which a specific colour is integrated which is arranged to merge into the colours applied subsequently in the cloth, and this without significantly impairing the quality of the camouflage obtained.

In the case where a composite yarn with a greater mechanical strength is required, it is also possible to include up to 30% thermostable fibers compared with the total weight of the yarn.

The thermostable fibers can be produced from a polymer material chosen from the group comprising para-aramids, meta-aramids, polybenzymidazole-imides, polybenzooxazoles, polyacrylates, polyphenols, polyamide-imides, poly-p-phenylenediamine-terephthalamides (PPTA or M5).

According to one embodiment, the fibers forming the yarn are mixed intimately by a conventional spinning technique. In this embodiment, the yarn can comprise between 10% and 20% thermostable fibers in order to optimise the ratio between the technical advantages conferred by these fibers with respect to their cost and colouring constraint.

In a particular example of a yarn according to this embodiment of the invention, it is possible to cite a yarn formed from 85% by weight commercial PVA FR fibers, (that is to say fibers formed from polyvinyl alcohol and an inclusion of polyvinyl chloride) and 15% by weight meta-aramid fibers, which has fire-resistant characteristics (in terms of LOI (Limit Oxygen Index), that is to say with a minimum concentration of oxygen necessary for causing the ignition of the yarn in contact with the flame), mechanical strength and colouring capacity which are particularly advantageous in the context of the applications in question. In particular, the yarn has an LOI defined according to ISO 4589-2 which is greater than 25%.

According to one embodiment, in particular in the case where a yarn with increased tenacity is required, the composite yarn comprises two types of thermostable fiber, one with standard tenacity—for example made from meta-aramid and the other with high tenacity—for example made from para-aramid. The term “high tenacity” means typically a tenacity greater than 10 cN/dtex, in particular greater than 15 cN/dtex.

In this embodiment, the yarn can be formed by an intimate mixture of the fibers as disclosed previously. By way of example, it is possible to cite a yarn formed from 85% by weight commercial PVA FR fibers, 10% by weight meta-aramid fibers and 5% by weight para aramid fibers.

In a variant, the yarn can be produced by a technique of the core-spun type. The yarn then comprises a core yarn formed with the high-tenacity thermostable fibers and, associated around the said core yarn, a coating formed from the other fibers. The quantity of thermostable fibers can then typically be fixed between 20% and 30% by weight of the yarn.

It should be noted that, in this embodiment, the colouring constraints of the high-tenacity thermostable fibers are not posed because they are disposed in the core yarn.

The invention therefore proposes a particular combination of fibers which makes it possible to optimally fulfil in particular the colouring constraints mentioned above, and this without affecting the performance, both fire resisting and mechanical, of the yarn. In addition, the yarn according to the invention makes it possible to obtain a textile of sufficient flexibility to obtain an advantageous feel, and this within a cost compatible with industrial production.

This is why the yarns according to the invention are in particular intended for producing a woven or knitted textile layer which is used in a textile for protective clothing.

As explained previously, the textile layer can advantageously be dyed or printed with a minimum amount of dichroism, in particular in a single phase, that is to say using a single colouring process, for example of the fixed washed type.

In addition, the textile can comprise, associated on the textile layer, an impermeable/breathable layer—that is to say impermeable to liquid water and wind but permeable to water vapour—non-flammable so as to confer this property on the protective garment made.

The impermeable/breathable layer can be produced in the form of a membrane or a microporous and/or hydrophilic coating, for example made from polyurethane or polytetrafluoroethylene (PTFE), and be associated with the textile layer by the screen-printed coating of a network of adhesive dots.

1. A fire-resisting composite yarn comprising:
between 70% and 90% by weight of flame-retardant fibers, the said fibers comprising a polymeric material based on polyvinyl alcohol;
between 10% and 30% by weight of at least one type of thermostable fibers which are formed from a non-flammable material.

2. A yarn according to claim 1, characterised in that the flame-retarded fibers also comprise a flame-retarding polymeric material.

3. A yarn according to claim 2, characterised in that the flame-retarding polymeric material is formed from polyvinyl halide, in particular polyvinyl chloride.

4. A yarn according to claim 1, characterised in that the thermostable fibers are produced from a polymeric material chosen from the group comprising para-aramids, meta-aramids, polybenzimidazole-imides, polybenzooxazoles, polyacrylates, polyphenols, polyamide-imides, poly-p-phenylediamine terephthalamides.

5. A yarn according to claim 1, characterised in that it comprises a type of high-tenacity thermostable fiber.

6. A yarn according to claim 1, characterised in that the fibers forming the yarn are mixed intimately.

7. A yarn according to claim 6, characterised in that it comprises between 10% and 20% by weight thermostable fibers.

8. A yarn according to claim 5, characterised in that it comprises a core yarn formed from high-tenacity fibers and, associated around the said core yarn, a coating formed from other fibers.

9. A yarn according to claim 8, characterised in that it comprises between 20% and 30% by weight thermostable fibers.

10. A textile intended for producing protective clothing, characterised in that it comprises at least one woven or knitted textile layer formed with yarns according to claim 1.

11. A textile according to claim 10, characterised in that the textile layer is dyed or printed.

12. A textile according to claim 10, characterised in that it comprises, associated with the textile layer, a non-flammable impermeable/breathable layer.

13. A textile according to claim 11, characterised in that it comprises, associated with the textile layer, a non-flammable impermeable/breathable layer.
